(19) United States
(12) Patent Application Publication
(10) Pub. No.: US 2012/0102081 A1
(43) Pub. Date: Apr. 26, 2012

(54) LOW-LATENCY ARC-TANGENT CALCULATION STRUCTURE AND CALCULATION METHOD THEREOF

(75) Inventors: TERNG-YIN HSU, HSINCHU CITY (TW); WEI-CHI LAI, HSINCHU CITY (TW)

(73) Assignee: NATIONAL CHIAO TUNG UNIVERSITY, HSINCHU CITY (TW)

(21) Appl. No.: 12/976,006

(22) Filed: Dec. 22, 2010

(30) Foreign Application Priority Data
Oct. 26, 2010 (TW) 099136530

(51) Int. Cl. G06F 7/48

(52) U.S. Cl. 708/209

(57) ABSTRACT

The present invention provides a low-latency arc-tangent calculation structure and a calculation method thereof. The arc-tangent calculation structure comprises two lookup tables, a subtractor, a sign comparator, a numerical comparator and a shift encoder. The present invention divides the coordinate system into a plurality of sectors for simplifying the lookup tables. The first lookup table is used to perform logarithmic transformation so as to replace a divider with a subtractor. The second lookup table integrates an exponentiation table and an angle table to translate the output of the subtractor into arc-tangent value θ. Then, θ is shifted to a correct angle according to the output of the shift encoder.

### BACKGROUND OF THE INVENTION

1. Field of the Invention

The present invention relates to an arc-tangent calculation method, particularly to a low-latency and divider-free arc-tangent calculation structure and a calculation method thereof.

2. Description of the Related Art

The arc-tangent function is expressed by

$${tan}^{- 1} ( \frac{y}{x} ) .$$

The calculation method thereof normally needs a divider, and the division result is used to find a corresponding angle from a lookup table. However, the divider is bulky, needs complicated hardware, and occupies considerable area.

In 1959, Volder published in IEEE a related paper “The CORDIC Trigonometric Computing Technique” that calculates the angle of an arc-tangent function without using any divider, wherein the coordinate system is divided into two parts, and wherein the part where the angle exists is determined. Next, the determined part is further divided into sub-parts again, and the sub-part where the angle exists is determined. The abovementioned dividing process is repeated until the angle is precisely defined. However, the prior art consumes too much time and greatly reduces the system efficiency.

Accordingly, the present invention proposes a low-latency arc-tangent calculation structure and a calculation method thereof to overcome the abovementioned problems. The architecture and embodiments thereof will be described in detail below.

### SUMMARY OF THE INVENTION

The primary objective of the present invention is to provide a low-latency arc-tangent calculation structure and a calculation method thereof, wherein the coordinate system is divided into a plurality of parts, and wherein the part where the angle exists is determined to exclude the other part irrespective of the angle, whereby the quantity of lookup calculations is greatly reduced.

Another objective of the present invention is to provide a low-latency arc-tangent calculation structure and a calculation method thereof, wherein the divider is exponentially converted into a subtractor, whereby is reduced calculation time and hardware complexity.

To achieve the abovementioned objectives, the present invention proposes a low-latency arc-tangent calculation structure, which is used to work out an arc-tangent value of the ratio of an X-axis value I to a Y-axis value Q, and which comprises two lookup tables; two multiplexers respectively determining the order that the X-axis value I and the Y-axis value Q enter into the lookup table, and determining the signs of the comparison results of the second lookup table; at least one comparator determining the signs and magnitudes of the X-axis value I and the Y-axis value Q; a control unit determining the sector where the point corresponding to the X-axis value I and the Y-axis value Q exists; a shift encoder determining a shift angle according to the output of the comparator; and an adder adding the shift angle output by the shift encoder to the output of the multiplexer.

The present invention also proposes a low-latency arc-tangent calculation method, which comprises steps: using a comparator to determine the signs and magnitudes of an X-axis value I and a Y-axis value Q; using two absolute generators to generate the absolute values of the X-axis value I and the Y-axis value Q; using a first lookup table to obtain the logarithms of the X-axis value I and the Y-axis value Q, and using a second lookup table to obtain the result of exponentiation with the base being the Euler's number and the exponent being the difference of the two logarithms, and obtain an angle corresponding to the arc-tangent value of the exponentiation result; using a control unit to determining the sector where the point corresponding to the X-axis value I and the Y-axis value Q exists; using a multiplexer to determine the sign of the output of the second lookup table according to the output of the control unit; using a shift encoder to determine a shift angle according to the output of the comparator; and adding the output of the shift encoder to the output of the multiplexer.

Below, the embodiments are described in detail to make easily understood the objectives, technical contents, characteristics and accomplishments of the present invention.

### BRIEF DESCRIPTION OF THE DRAWINGS

FIG. 1 is a diagram schematically showing an arc-tangent calculation structure according to one embodiment of the present invention;

FIG. 2 is a flowchart of a low-latency arc-tangent calculation method according to one embodiment of the present invention; and

FIG. 3 is a diagram schematically showing that a coordinate system is divided into eight sectors to calculate the arc-tangent value of a point (Iᵢ, Qᵢ) according to one embodiment of the present invention.

### DETAILED DESCRIPTION OF THE INVENTION

The present invention proposes a low-latency arc-tangent calculation structure and a calculation method thereof, wherein the present invention divides a coordinate system into a plurality of sectors, based on the characteristic of the arc-tangent function, and wherein the present invention completely replaces division operations with subtraction operations via logarithmic and exponential transformations, and wherein the present invention finds out the sector where the angle exists, whereby the calculation time is greatly reduced.

In one embodiment, the X-Y coordinate system is equally divided into eight sectors, and each sector has an angle of 45 degrees. In such a case, the arc-tangent function can be expressed by Equation (1):

$$\begin{matrix}{θ}_{i} = {tan}^{- 1} ( \frac{{Q}_{i}}{{I}_{i}} ) \\ = \{ \begin{matrix}{tan}^{- 1} ( {e}^{lo g \vert {Q}_{i} \vert - lo g \vert {I}_{i} \vert} ) + 0 ° , \\ where \vert {I}_{i} \vert > \vert {Q}_{i} \vert \& \{ sign ( {I}_{i} ) , sign ( {Q}_{i} ) \} = \{ + , + \} \\ - {tan}^{- 1} ( {e}^{lo g \vert {I}_{i} \vert - l og \vert {Q}_{i} \vert} ) + 90 ° , \\ where \vert {I}_{i} \vert < \vert {Q}_{i} \vert \& \{ sign ( {I}_{i} ) , sign ( {Q}_{i} ) \} = \{ + , + \} \\ {tan}^{- 1} ( {e}^{lo g \vert {Q}_{i} \vert - lo g \vert {I}_{i} \vert} ) + 180 ° , \\ where \vert {I}_{i} \vert > \vert {Q}_{i} \vert \& \{ sign ( {I}_{i} \} , sign ( {Q}_{i} ) \} = \{ - , - \} \\ - {tan}^{- 1} ( {e}^{l o g \vert {I}_{i} \vert - lo g \vert {Q}_{i} \vert} ) + 270 ° , \\ where \vert {I}_{i} \vert < \vert {Q}_{i} \vert \& \{ sign ( {I}_{i} ) , sign ( {Q}_{i} ) \} = \{ - , - \} \\ - {tan}^{- 1} ( {e}^{lo g \vert {Q}_{i} \vert - l og \vert {I}_{i} \vert} ) + 360 ° , \\ where \vert {I}_{i} \vert > \vert {Q}_{i} \vert \& \{ sign ( {I}_{i} ) , sign ( {Q}_{i} ) \} = \{ + , - \} \\ {tan}^{- 1} ( {e}^{lo g \vert {I}_{i} \vert - lo g \vert {Q}_{i} \vert} ) + 270 ° , \\ where \vert {I}_{i} \vert < \vert {Q}_{i} \vert \& \{ sign ( {I}_{i} ) , sign ( {Q}_{i} ) \} = \{ + , - \} \\ - {tan}^{- 1} ( {e}^{lo g \vert {Q}_{i} \vert - l og \vert {I}_{i} \vert} ) + 180 ° , \\ where \vert {I}_{i} \vert > \vert {Q}_{i} \vert \& \{ sign ( {I}_{i} ) , sign ( {Q}_{i} ) \} = \{ - , + \} \\ {tan}^{- 1} ( {e}^{lo g \vert {I}_{i} \vert - lo g \vert {Q}_{i} \vert} ) + 90 ° , \\ where \vert {I}_{i} \vert < \vert {Q}_{i} \vert \& \{ sign ( {I}_{i} ) , sign ( {Q}_{i} ) \} = \{ - , + \}\end{matrix}\end{matrix} \qquad ( 1 )$$

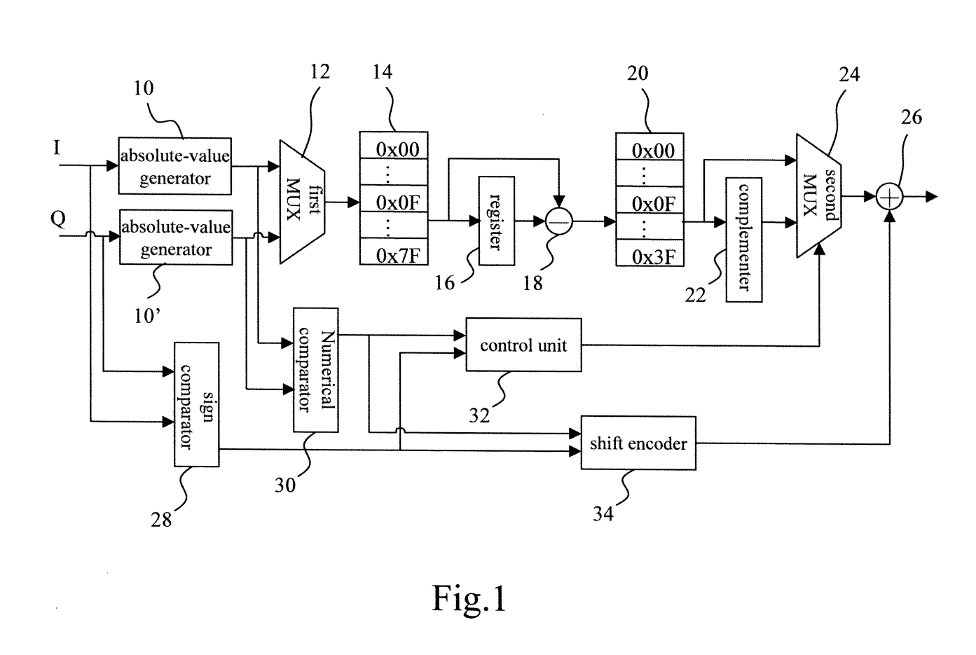

Refer to FIG. 1 a diagram schematically showing an arc-tangent calculation structure for working out an angle corresponding to the arc-tangent value of a ratio of an X-axis value I to a Y-axis value Q. The structure comprises two absolute-value generators 10 and 10′, a first multiplexer 12, a first lookup table 14, a register 16, a subtractor 18, a second lookup table 20, a complementer 22, a second multiplexer 24, an adder 26, a sign comparator 28, a numerical comparator 30, a control unit 32 and a shift encoder 34.

The two absolute-value generators 10 and 10′ respectively generate the absolute values of the X-axis value I and the Y-axis value Q, and send the absolute values to the first multiplexer 12 and the numerical comparator 30. The first multiplexer 12 determines the order of absolutely X-axis value I and absolutely Y-axis value Q go to the first look up table 14 according which number is smaller. The first look up table 14 works out the logarithms of the X-axis value I and the Y-axis value Q. The worked out logarithms are stored in the register 16. The subtractor 18 calculates the difference between the logarithms of the X-axis value I and the Y-axis value Q. The second lookup table 20 includes an exponentiation lookup table and an angle lookup table. From the second lookup table is obtain the exponentiation result of the abovementioned difference. Further from the second lookup table is obtained an arc-tangent value (an angle) corresponding to the exponentiation result. The complementer 22 adds a minus sign to the output of the second lookup table 20. Suppose that the output of the second lookup table 20 is a positive value. After the complementer 22 adds a minus sign to the positive value, the positive value is converted into a negative value. Thereby, the second multiplexer 24 simultaneously receives a positive input and a negative input. The second multiplexer 24 calculates to determine whether to output a positive value or a negative value. The sign comparator 28 and the numerical comparator 30 respectively determine the signs and magnitudes of the X-axis value I and the Y-axis value Q. The X-axis value I and the Y-axis value Q are directly sent to the sign comparator 28 before being processed by the absolute-value generators 10 and 10′. The X-axis value I and the Y-axis value Q are sent to the numerical comparator 30 after being processed by the absolute-value generators 10 and 10′. The two comparators 28 and 30 may be regarded as a single comparator. The control unit 32 determines the sector where a point corresponding to the X-axis value I and the Y-axis value Q exists. In one embodiment, the coordinate system is divided into eight sectors each having an angle of 45 degrees. The shift encoder 34 determines the shift angle according to the outputs of the sign comparator 28 and the numerical comparator 30. The adder 26 adds the shift angle output by the shift encoder 34 to the output of the second multiplexer 24.

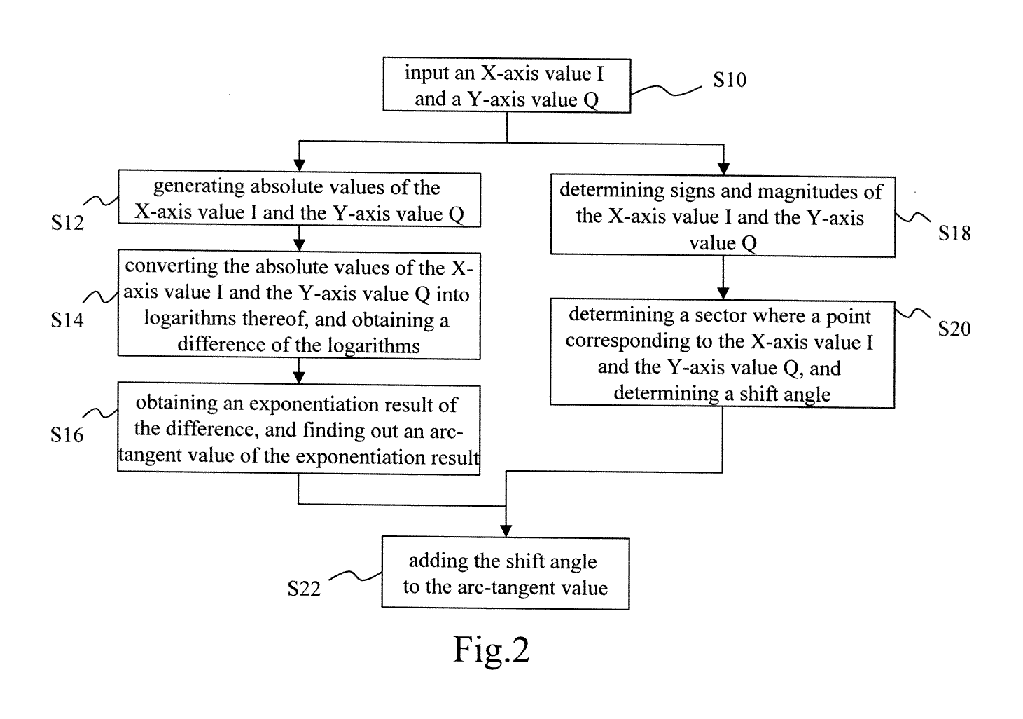

Refer to FIG. 2 for a flowchart of a low-latency arc-tangent calculation method. In Step S10, input an X-axis value I and a Y-axis value Q. In Step S12, use two absolute-value generators to respectively generate the absolute values of the X-axis value I and the Y-axis value Q. In Step S14, use a first look up table to convert the absolute values of the X-axis value I and the Y-axis value Q into the logarithms thereof (log I and log Q), store the logarithms in a register, and use a subtractor to calculate the difference of the logarithms (log Q−log I). According to the absolutely value of Q and I, it can be either log Q−log I or log I−log Q. In Step S16, find out an exponentiation result e^{log Q-log I} of the logarithm difference (log Q−log I) from a second lookup table, and find out an angle corresponding to the arc-tangent value of the exponentiation result from the second lookup table. Both the exponentiation result and angle are positive values. A complementer adds minus signs to the positive values to obtain two negative values. The positive and negative values are input to a second multiplexer.

On the other hand, after the values of the X-axis value I and the Y-axis value Q are input in Step S10, use a comparator to determine the signs and magnitudes of the X-axis value I and the Y-axis value Q in Step S18. In the embodiment shown in FIG. 1, a sign comparator is used to determine the signs of the X-axis value I and the Y-axis value Q, and a numerical comparator is used to determine whether the magnitude of the X-axis value is smaller or greater than that of the Y-axis value. In the present invention, the coordinate system is divided into a plurality of sectors, for example, eight sectors each having an angle of 45 degrees. In Step S20, use a control unit to determine the sector where a point corresponding to the X-axis value I and the Y-axis value Q exists. In other words, determine the magnitudes of ∥Iᵢ∥ and ∥Qᵢ∥, and {sign(Iᵢ), sign(Qᵢ)}. Thereby, the second multiplexer can determine the sign of the arc-tangent value and whether to add a minus sign to tan⁻¹ shown in Equation (1) according to the magnitudes of ∥Iᵢ∥ and ∥Qᵢ∥, and {sign(Iᵢ), sign(Qᵢ)}. Similarly, a shift encoder determines the shift angle according to the magnitudes of ∥Iᵢ∥ and ∥Qᵢ∥, and {sign(Iᵢ), sign(Qᵢ)}. Then, in Step S22, add the shift angle output by the shift encoder to the output of the second multiplexer to obtain the arc-tangent value of (Iᵢ, Qᵢ).

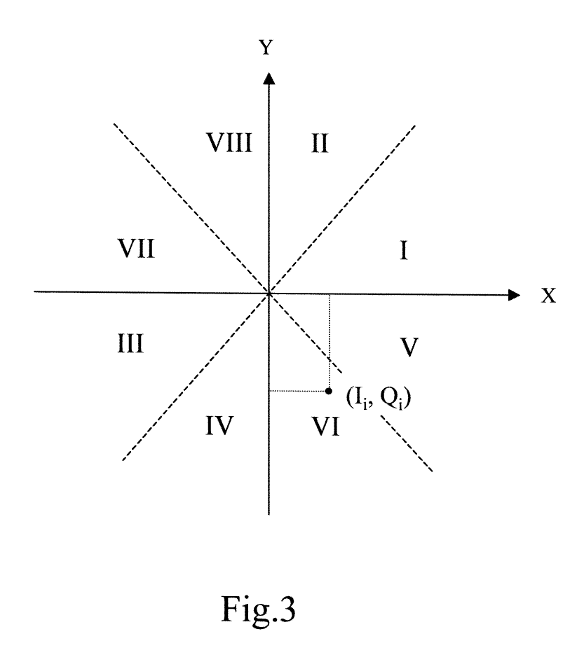

Refer to FIG. 3 a diagram schematically showing a coordinate system divided into eight sectors according to one embodiment of the present invention. In this embodiment, each sector has an angle of 45 degrees. The eight sectors are respectively the first, second eighth, seventh, third, fourth, sixth and fifth sectors in counterclockwise sequence from the positive X axis. Below is demonstrated how to calculate the angle corresponding

$${tan}^{- 1} ( \frac{{Q}_{i}}{{I}_{i}} ) .$$

From the position where the point (Iᵢ, Qᵢ) is located in the coordinate system, it is known that ∥Iᵢ∥<∥Qᵢ∥ and that Iᵢ has a positive value and Qᵢ has a negative value, i.e. {sign(Iᵢ), sign(Qᵢ)}={+, −}. Therefore, the point (Iᵢ, Qᵢ) is located in the sixth sector. Thus, the shift angle is 270 degrees, and the angle corresponding to

$${tan}^{- 1} ( \frac{{Q}_{i}}{{I}_{i}} )$$

has a value of tan⁻¹(e^{log|I}^{ᵢ}^{|-log|Q}^{ᵢ}^{|})+270°.

In conclusion, the present invention proposes a low-latency arc-tangent calculation structure and a method thereof, which replaces a divider with a subtractor to reduce calculation time and decrease the area occupied by hardware. In the present invention, the coordinate system is divided into a plurality of sectors, whereby the corresponding angle can be worked out with only two lookup tables, and whereby the invention can further reduce calculation complexity and promote system efficiency.

The embodiments described above are only to exemplify the present invention but not to limit the scope of the present invention. Any equivalent modification or variation according to the spirit of the present invention is to be also included within the scope of the present invention.

What is claimed is:

1. A low-latency arc-tangent calculation structure, used to work out an arc-tangent value of a ratio of an X-axis value I to a Y-axis value Q, comprising
two lookup tables including a first lookup table and a second lookup table;
two multiplexers respectively determining a order that said X-axis value I and said Y-axis value Q enter into said first lookup table and determining signs of outputs of said second lookup table;
at least one comparator determining signs and magnitudes of said X-axis value I and said Y-axis value Q;
a control unit determining a sector of a coordinate system, at which a point corresponding to said X-axis value I and said Y-axis value Q exists;
a shift encoder determining a shift angle according to outputs of said comparator; and
an adder adding said shift angle to an output of said multiplexers.

2. The low-latency arc-tangent calculation structure according to claim 1 further comprising two absolute-value generators that generate absolute values of said X-axis value I and said Y-axis value Q and send said absolute values to said multiplexers and said comparator.

3. The low-latency arc-tangent calculation structure according to claim 1, wherein said comparator includes a sign comparator and a numerical comparator respectively determining signs and magnitudes of said X-axis value I and said Y-axis value Q.

4. The low-latency arc-tangent calculation structure according to claim 1, wherein said first lookup table is used to convert said X-axis value I and said Y-axis value Q into logarithms of said X-axis value I and said Y-axis value Q.

5. The low-latency arc-tangent calculation structure according to claim 1, wherein said second lookup table integrates an exponentiation lookup table and an angle lookup table.

6. The low-latency arc-tangent calculation structure according to claim 4, wherein said second lookup table is used to obtain an exponentiation result of a difference of said logarithms of said X-axis value I and said Y-axis value Q and obtain an angle corresponding to an arc-tangent value of said exponentiation result.

7. The low-latency arc-tangent calculation structure according to claim 1 further comprising a register storing outputs of said first lookup table with respect to said X-axis value I and said Y-axis value Q.

8. The low-latency arc-tangent calculation structure according to claim 1, wherein said two multiplexers includes a first multiplexer and a second multiplexer, and wherein said first multiplexer determines the order of absolutely said X-axis value I and absolutely said Y-axis value Q go to said first look up table according which number is smaller.

9. The low-latency arc-tangent calculation structure according to claim 1 further comprising a subtractor used to work out a difference of logarithms of said X-axis value I and said Y-axis value Q, which are obtained from said first lookup table.

10. The low-latency arc-tangent calculation structure according to claim 8, wherein said second multiplexer determines signs of outputs of said second lookup table according to outputs of said control unit.

11. The low-latency arc-tangent calculation structure according to claim 1, wherein said control unit divides said coordinate system into eight sectors each having an angle of 45 degrees.

12. A low-latency arc-tangent calculation method, used to work out an arc-tangent value of a ratio of an X-axis value I to a Y-axis value Q, comprising steps:
using at least one comparator to determine signs and magnitudes of said X-axis value I and said Y-axis value Q;
using two absolute-value generators to generate absolutes of said X-axis value I and said Y-axis value Q;
using a first lookup table to obtain logarithms of said X-axis value I and said Y-axis value Q, and using a second lookup table to obtain an exponentiation result of a difference of said logarithms of said X-axis value I and said Y-axis value Q and obtain an arc-tangent value of said exponentiation result;
using a control unit to determine a sector of a coordinate system, at which a point corresponding to said X-axis value I and said Y-axis value Q exists;
using a multiplexer to determine signs of outputs of said second lookup table according to outputs of said control unit, and using a shift encoder to determine a shift angle according to outputs of said comparator; and
adding said shift angle to an output of said multiplexer.

13. The low-latency arc-tangent calculation method according to claim 12, wherein said comparator includes a sign comparator and a numerical comparator respectively determining signs and magnitudes of said X-axis value I and said Y-axis value Q.

14. The low-latency arc-tangent calculation method according to claim 12, wherein said second lookup table integrates an exponentiation lookup table and an angle lookup table.

15. The low-latency arc-tangent calculation method according to claim 12, further comprising a register storing outputs of said first lookup table with respect to said X-axis value I and said Y-axis value Q.

16. The low-latency arc-tangent calculation method according to claim 12, wherein a subtractor works out said difference of said logarithms and sends said difference to said second lookup table.

17. The low-latency arc-tangent calculation method according to claim 12, wherein said absolutes of said X-axis value I and said Y-axis value Q go into said first lookup table in a order determined by a first multiplexer and then sends results of said logarithmic operations to a register storing outputs of said first lookup table.

18. The low-latency arc-tangent calculation method according to claim 12, wherein said control unit divides said coordinate system into eight sectors each having an angle of 45 degrees.
